(19) United States
(12) Patent Application Publication
(10) Pub. No.: US 2025/0298976 A1
(43) Pub. Date: Sep. 25, 2025

(54) TEXT SIMILARITY RECOGNITION

(71) Applicant: MASHANG CONSUMER FINANCE CO., LTD., Chongqing (CN)

(72) Inventor: Changlin LI, Chongqing (CN)

(73) Assignee: MASHANG CONSUMER FINANCE CO., LTD., Chongqing (CN)

(21) Appl. No.: 18/970,868

(22) Filed: Dec. 5, 2024

(30) Foreign Application Priority Data
Mar. 19, 2024 (CN) 202410318340.2

(51) Int. Cl. G06F 40/279; G06F 40/205

(52) U.S. Cl. CPC G06F 40/279; G06F 40/205

(57) ABSTRACT

A method for text similarity recognition method includes: obtaining a first text and a second text; determining a multi-dimensional similarity feature for the first text and the second text, where the multi-dimensional similarity feature includes at least one of a word dimensional similarity feature, a sentence dimensional similarity feature, or a full-text dimensional similarity feature; and determining a recognition result indicating similarity between the first text and the second text based on the multi-dimensional similarity feature.

### CROSS-REFERENCE TO RELATED APPLICATION

This application claims priority to and the benefit of Chinese Patent Application No. 202410318340.2, filed on Mar. 19, 2024, the disclosure of which is incorporated herein by reference in its entirety.

### TECHNICAL FIELD

The present disclosure relates to artificial intelligence technologies, and more particularly, to text similarity recognition.

### BACKGROUND

Text similarity recognition can be applied in many scenarios such as text classification and search scenarios. Generally, a method may be adopted in which different texts are characterized by respective vectors and the similarity between the different texts is determined based on the respective vectors thereof. However, with this method, only semantics of the full-text is considered based on the text vector, resulting in lower accuracy.

### SUMMARY

According to one or more embodiments of the present disclosure, a method for text similarity recognition includes: obtaining a first text and a second text; determining a multi-dimensional similarity feature for the first text and the second text, where the multi-dimensional similarity feature includes at least one of a word dimensional similarity feature characterizing similarity between the first text and the second text in a word dimension, a sentence dimensional similarity feature characterizing similarity between the first text and the second text in a sentence dimension, or a full-text dimensional similarity feature characterizing similarity between the first text and the second text in a full-text dimension; and determining a recognition result indicating similarity between the first text and the second text based on the multi-dimensional similarity feature.

According to one or more embodiments of the present disclosure, an electronic device includes at least one processor and a memory communicatively connected with the at least one processor. The memory stores one or more computer programs executable by the at least one processor to perform the method for text similarity recognition as described above.

According to one or more embodiments of the present disclosure, a non-transitory computer-readable storage medium stores a computer program executable by a processor to perform the method for text similarity recognition as described above.

### BRIEF DESCRIPTION OF THE DRAWINGS

FIG. 1 is a schematic diagram of a scenario where a method for text similarity recognition according to one or more embodiments of the present disclosure can be applied.

FIG. 2 is a flowchart of a method for text similarity recognition according to one or more embodiments of the present disclosure.

FIG. 3 is a flowchart of a process for training a recognition model according to one or more embodiments of the present disclosure.

FIG. 4 is a block diagram of an apparatus for text similarity recognition according to one or more embodiments of the present disclosure.

FIG. 5 is a block diagram of an electronic device according to one or more embodiments of the present disclosure.

FIG. 6 is a flowchart of a process for determining the multi-dimensional similarity features for the first text and the second text according to one or more embodiments of the present disclosure.

FIG. 7 is a flowchart of a process for determining the multi-dimensional similarity feature for the first text and the second text according to one or more embodiments of the present disclosure.

FIG. 8 is a flowchart of a process for determining the multi-dimensional similarity feature for the first text and the second text according to one or more embodiments of the present disclosure.

FIG. 9 is a flowchart of a process for determining the multi-dimensional similarity feature for the first text and the second text according to one or more embodiments of the present disclosure.

FIG. 10 is a flowchart of a process for determining the multi-dimensional similarity feature for the first text and the second text according to one or more embodiments of the present disclosure.

FIG. 11 is a flowchart of a process for determining the multi-dimensional similarity feature for the first text and the second text according to one or more embodiments of the present disclosure.

FIG. 12 is a flowchart of a process for determining the multi-dimensional similarity feature for the first text and the second text according to one or more embodiments of the present disclosure.

### DETAILED DESCRIPTION

In order that the technical solution of the present disclosure may be better understood by a person of ordinary skill in the art, exemplary embodiments of the present disclosure will now be described in conjunction with the accompanying drawings, in which various details of the embodiments of the present disclosure are included to facilitate understanding, and are to be considered as exemplary only. Accordingly, a person of ordinary skill in the art will recognize that various changes and modifications may be made to the embodiments described herein without departing from the scope and spirit of the present disclosure. Also, for clarity and conciseness, descriptions of well-known functions and structures are omitted from the following description.

In the absence of conflict, the various embodiments and features within the embodiments of the present disclosure may be combined with each other.

The term “and/or” as used herein includes any and all combinations of one or more related listed items.

The terms used herein are for the sole purpose of describing specific embodiments and are not intended to limit the present disclosure. As used herein, the singular forms “a” and “the” are intended to include the plural forms unless the context clearly indicates otherwise. It should be understood that when the terms “comprising/including” and/or “consisting of” are used in this specification, they specify the presence of the stated features, entities, steps, operations, elements and/or components, but do not preclude the presence or addition of one or more other features, entities, steps, operations, elements, components and/or combinations thereof. The words “connected” or “connected to” and similar terms are not limited to physical or mechanical connections but may include electrical connections, whether direct or indirect.

Unless otherwise defined, all terms used herein (including technical and scientific terms) have the same meanings as commonly understood by a person of ordinary skill in the field. It will also be understood that terms defined in commonly used dictionaries should be interpreted to have meanings consistent with their meanings in the relevant technology and the context of the present disclosure, and are not to be interpreted as having idealized or overly formal meanings unless specifically defined as such herein.

In the technical solution of the present disclosure, the collection, storage, use, processing, transmission, provision, and public disclosure of personal user information are all in compliance with relevant laws and regulations and do not violate public order and good customs. For instance, personal information access control adopts corresponding regulatory measures; the display of personal information is subject to regulatory restrictions; the purpose of using personal information does not exceed the scope of direct or reasonable association; and the use of personal information eliminates clear identity reference to avoid precise location of specific individuals.

In the description of the present disclosure, it is to be understood that the terms “first”, “second” and the like are used for descriptive purposes only and are not to be construed as indicating or implying relative importance or implying the number of indicated technical features. Thus, features defined as “first” and “second” may explicitly or implicitly include one or more of the described features. In the description of present disclosure, “plural” means two or more, unless expressly and specifically defined otherwise. “Electrical connection” means that there is conductivity between the two, without limitation to being directly or indirectly connected.

In addition, it should also be noted that the drawings provided only depict structures and steps closely related to the present disclosure, omitting some details that are not relevant to the present disclosure. The purpose is to simplify the drawings and make the essential points of the present disclosure clear, rather than indicating that an actual device must be identical to the drawings. The drawings are not intended to limit the actual implementation of the device.

According to some embodiments of the present disclosure, a method for text similarity recognition involves obtaining a first text and a second text, determining a multi-dimensional similarity feature for the first text and the second text, and then determining a recognition result indicating similarity between the first text and the second text based on the multi-dimensional similarity feature. The multi-dimensional similarity feature includes at least one of a word dimensional similarity feature, a sentence dimensional similarity feature, or a full-text dimensional similarity feature. In this way, features may be extracted from multiple dimensions such as words, sentences, and the full-text, and the similarity of the texts may be determined, improving the accuracy of text similarity recognition. Moreover, multi-dimensional similarity feature does not require vector representation, making the feature extraction faster and increasing the recognition rate.

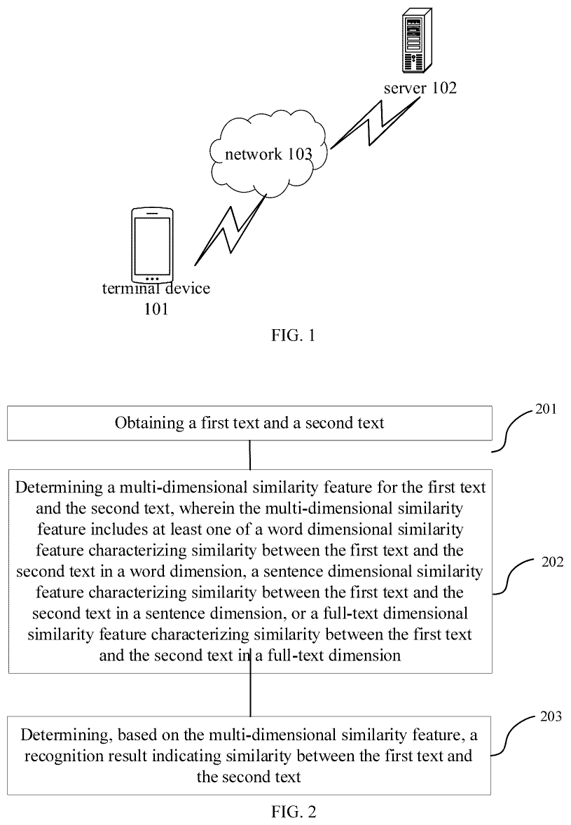

FIG. 1 schematically illustrates a scenario where a method and an apparatus for text similarity recognition according to one or more embodiments of the present disclosure can be applied.

As shown in FIG. 1, an application scenario of one or more embodiments of the present disclosure may include a terminal device 101, a network 103, and a server 102. The network 103 is used to provide a medium for the communication link between the terminal device 101 and the server 102. The network 103 may include various types of connections, such as wired, wireless communication links, or fiber optic cables, etc.

A user may interact with the server 102 through the network 103 using the terminal device 101 to receive or transmit messages, etc. Various communication client applications, by way of example only, such as shopping applications, web browser applications, search applications, instant messaging tools, mailbox clients, social platform software, and the like may be installed on the terminal device 101.

The terminal device 101 may be various electronic devices having a display screen and supporting web page browsing, including, but not limited to, a smartphone, a tablet, a portable computer, a desktop computer, and the like.

The server 102 may be a server that provides various services, by way of example only, such as a backend management server that provides support to a website that a user browses using the terminal device 101. The backend management server may analyze the received data such as user requests, and feed the processed results (for example, a web page, information, or data obtained or generated according to the user requests) back to the terminal device.

It should be noted that the method and apparatus for text similarity recognition provided in the embodiments of the present disclosure may be performed by the server 102. Accordingly, the method and apparatus for text similarity recognition provided by the embodiments of the present disclosure may be provided in the server 102. The method and apparatus for text similarity recognition provided by the embodiments of the present disclosure may also be performed by a server or cluster of servers different from the server 102 and capable of communicating with the terminal device 101 and/or the server 102. Accordingly, the method and apparatus for text similarity recognition provided by the embodiments of the present disclosure may also be provided in a server or cluster of servers different from the server 102 and capable of communicating with the terminal device 101 and/or the server 102.

It should be understood that the number of terminal devices, networks and servers in FIG. 1 is merely illustrative. There may be any number of terminal devices, networks, and servers as desired for implementation.

FIG. 2 is a flowchart of a method for text similarity recognition according to one or more embodiments of the present disclosure. Referring to FIG. 2, the method includes the following steps S201 to S203.

Step S201: Obtaining a first text and a second text.

In the embodiments of the present disclosure, the first text and the second text may be a pair of texts in any scenario between which similarity is to be recognized, for example, a pair of letter texts, a pair of article or paper texts, a pair of contract texts, or the like.

Step S202: Determining a multi-dimensional similarity feature for the first text and the second text, wherein the multi-dimensional similarity feature includes at least one of a word dimensional similarity feature characterizing similarity between the first text and the second text in a word dimension, a sentence dimensional similarity feature characterizing similarity between the first text and the second text in a sentence dimension, or a full-text dimensional similarity feature characterizing similarity between the first text and the second text in a full-text dimension.

Step S203: Determining, based on the multi-dimensional similarity feature, a recognition result indicating similarity between the first text and the second text.

In some embodiments of the present disclosure, the operation at step S203 may be implemented by: inputting a value of the multi-dimensional similarity feature to a recognition model, so that similarity between the first text and the second text is recognized by the recognition model to obtain the recognition result indicating similarity between the first text and the second text. The recognition model can be obtained by training a neural network model based on a set of training text pairs. Each training text pair in the set of training text pairs includes a multi-dimensional similarity feature and a similarity label for a first training text and a second training text.

In the embodiments of the present disclosure, a recognition model suitable for a distinct application scenario may be pre-trained based on a set of training text pairs for that application scenario, and is utilized to identify whether the texts are similar. For example, the multi-dimensional similarity feature of the first text and the second text includes six features, the values of which may be converted into an array format as a feature value array. This feature value array is input into the recognition model, and then the recognition model analyzes and recognizes based on this feature value array to obtain the recognition result indicating similarity between the first text and the second text, that is, the recognition model may output a result indicating whether the first text and the second text are similar or not.

Furthermore, in the embodiments of the present disclosure, the order of each feature in the array after the value conversion of the multi-dimensional similarity feature is not restricted. For example, in practical applications, the order of each feature in the array is the same as the order during the training of the recognition model.

Additionally, to further improve the recognition accuracy of the model, normalization processing of the value of the multi-dimensional similarity feature may also be performed before inputting into the recognition model, which may reduce the impact of the weight of a single feature being too dominant or too minor on the accuracy of similarity recognition.

Furthermore, in the embodiments of the present disclosure, several possible application scenarios are also provided. After determining the recognition result indicating similarity between the first text and the second text based on the multi-dimensional similarity feature, different subsequent treatments may be carried out for different application scenarios.

In one possible implementation, when the first text and the second text are letter texts, similarity recognition results from a plurality of letter texts may be used to screen out those letter texts that are identified as similar. In addition, it is possible to ascertain a source of the screened letter texts and determine if the source is abnormal. An alarm is issued when the source is determined to be an abnormal source.

For example, in the financial field, users may send letters to relevant companies based on third-party agents, which may cause certain troubles to the companies. Therefore, it is crucial to identify, among a large volume of received letters, those that are sent by third-party agents, so that targeted treatment may be carried out. Since the letters sent by third-party agents has a certain similarity, the method for text similarity recognition in the embodiments of the present disclosure may be used to identify similar letters from the large volume of received letters, and then determine the source of these similar letters. When it is determined to be an abnormal source, for example, an abnormal source is a certain third-party agent, an alarm may be issued, and relevant personnel or departments may track and handle it.

In another possible implementation, whether there is plagiarism between the first text and the second text may be determined according to the similarity recognition result.

For example, in the plagiarism detection scenario, under a condition that the first text and the second text are identified as not similar, it is determined that there is no plagiarism between the first text and the second text. Alternatively, under a condition that the first text and the second text are identified as similar, it is determined that there is plagiarism between the first text and the second text. In addition, when plagiarism is determined to exist, the recognized similar or repeated portion(s) may also be output and displayed, making it easier for users to clearly and conveniently know the similar content.

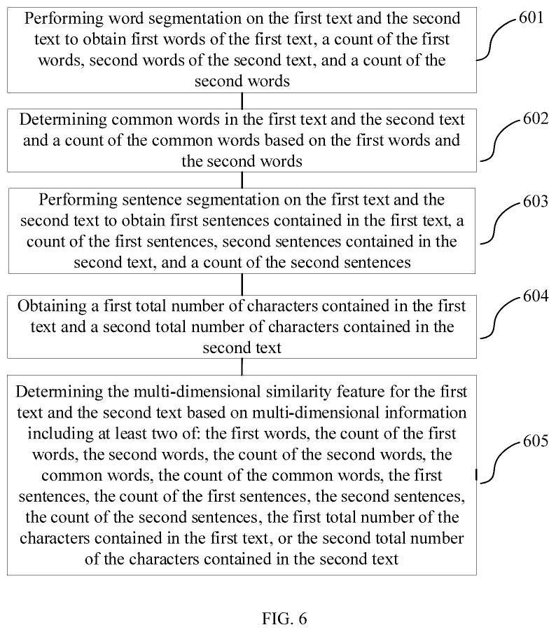

In the embodiments of the present disclosure, the multi-dimensional similarity feature may be calculated and obtained based on pre-established calculation formulas. These features, which characterize the degree of similarity between texts, may be pre-constructed. Subsequently, according to the calculation formula corresponding to each similarity feature, the similarity features for the first text and the second text may be extracted. In some embodiments of the present disclosure, the multi-dimensional similarity features for the first text and the second text may be determined for step S202 by the following operations as shown in FIG. 6.

FIG. 6 is a flowchart of a process for determining the multi-dimensional similarity features for the first text and the second text according to one or more embodiments of the present disclosure. Referring to FIG. 6, the process includes the following steps S601 to S605.

Step 601: Performing word segmentation on the first text and the second text to obtain first words of the first text, a count of the first words, second words of the second text, and a count of the second words.

Further, in the embodiments of the present disclosure, deduplication processing may be further performed after word segmentation, and the number of occurrences of repeated words may also be recorded so that subsequent statistics and calculations may be facilitated, thereby improving efficiency.

For example, word segmentation may be performed on the first text (textA) and the second text (textB) based on the n-gram model methodology, respectively, and deduplication may be performed to obtain first words, textA_words, with a count of M, and second words, textB_words, with a count of N.

Here, the length n of the segmentation in the n-gram methodology is not limited. For example, the value of n is 8. The value of n may be set according to requirements and actual experience.

Step 602: Determining common words in the first text and the second text and a count of the common words based on the first words and the second words.

For example, by taking an intersection of the first words textA words and the second words textB_words, it is possible to obtain common words, all_words=[k₁, k₂, . . . , kₘ], with a count of m.

Step 603: Performing sentence segmentation on the first text and the second text to obtain first sentences contained in the first text, a count of the first sentences, second sentences contained in the second text, and a count of the second sentences.

For example, sentence segmentation may be performed based on punctuations in the texts, obtaining first sentences, textA_s, with a count of T_{A}, and second sentences, textB_s, with a count of T_{B}.

Step 604: Obtaining a first total number of characters contained in the first text and a second total number of characters contained in the second text.

For example, the first total number of characters in the first text is Q_{A}, and the second total number of characters in the second text is Q_{B}.

For example, the first total number of characters and the second total number of characters may each be a word count.

Step 605: Determining the multi-dimensional similarity feature for the first text and the second text based on multi-dimensional information including at least two of: the first words, the count of the first words, the second words, the count of the second words, the common words, the count of the common words, the first sentences, the count of the first sentences, the second sentences, the count of the second sentences, the first total number of the characters contained in the first text, or the second total number of the characters contained in the second text.

In this way, in the embodiments of the present disclosure, the feature calculation may be performed according to the multi-dimensional information of the first text and the second text, thereby obtaining the desired multi-dimensional similarity feature, and improving the accuracy of the similarity recognition.

The operation at step S202 will be described in detail with respect to the calculation formulas for the respective dimensional similarity features.

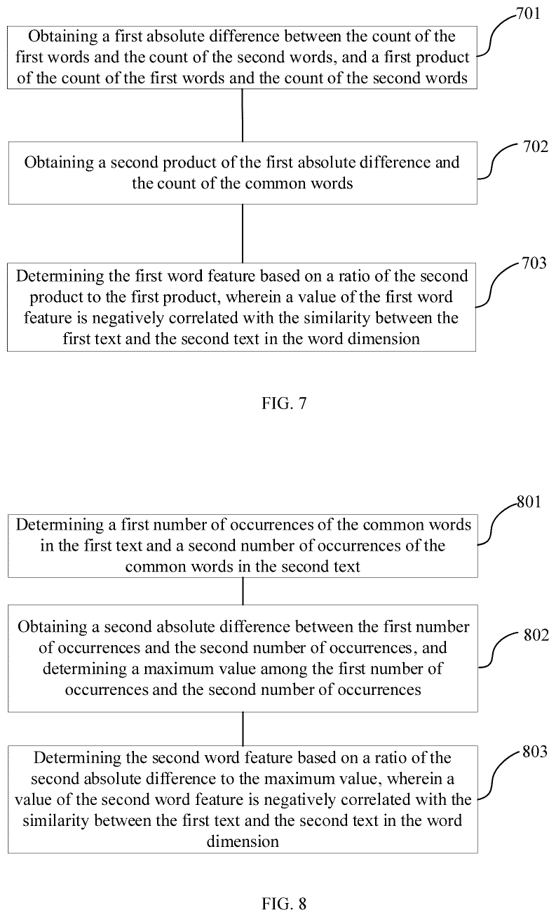

In a possible embodiment, the multi-dimensional similarity feature includes a first word feature that characterizes the word dimensional similarity feature, and the determining the multi-dimensional similarity feature for the first text and the second text based on multi-dimensional information includes the following operations as shown in FIG. 7.

FIG. 7 is a flowchart of a process for determining the multi-dimensional similarity feature for the first text and the second text according to one or more embodiments of the present disclosure. Referring to FIG. 7, the process includes the following steps S701 to S703.

Step 701: Obtaining a first absolute difference between the count of the first words and the count of the second words, and a first product of the count of the first words and the count of the second words.

For example, given that the count of the first words is M and the count of the second words is N, the first absolute difference between the count of the first words and the count of the second words is |M−N|, and the first product of the count of the first words and the count of the second words is M*N.

Step 702: Obtaining a second product of the first absolute difference and the count of the common words.

For example, the count of the common words is m, and the second product of the first absolute difference and the count of the common words is m*|M−N|.

Step 703: Determining the first word feature based on a ratio of the second product to the first product, wherein a value of the first word feature is negatively correlated with the similarity between the first text and the second text in the word dimension.

For example, given that the first word feature is denoted as a, then the calculation formula of the first word feature is:

$$a = \frac{m * \vert M - N \vert}{M * N} .$$

In the embodiments of the present disclosure, the first word feature a may denote the absolute value of the difference between the proportions of the common words in the word bases textA_words and textB_words. Therefore, the smaller the value of the first word feature, the more common words may be included in the first text and the second text, the greater the degree of similarity between the first text and the second text.

In a possible embodiment, the multi-dimensional similarity feature includes a second word feature that characterizes the word dimensional similarity feature, and the determining the multi-dimensional similarity feature for the first text and the second text based on multi-dimensional information includes the following operations as shown in FIG. 8.

FIG. 8 is a flowchart of a process for determining the multi-dimensional similarity feature for the first text and the second text according to one or more embodiments of the present disclosure. Referring to FIG. 8, the process includes the following steps S801 to S803.

Step 801: Determining a first number of occurrences of the common words in the first text and a second number of occurrences of the common words in the second text.

In the embodiments of the present disclosure, after word segmentation processing is performed on the first text and the second text, there may be a plurality of identical words. The number of occurrences of each word may be recorded, so that a first number of occurrences of a common word in the first text and a second number of occurrences of the common word in the second text may be obtained. In cases where there are a plurality of common words, the first number of occurrences and the second number of occurrences may be obtained for each common word, respectively. Subsequently, a sum of the first numbers of occurrences and a sum of the second numbers of occurrences for the plurality of common words may be calculated.

For example, the count of the common words is m, the first number of occurrences of the m common words in the first text, textA, is text_Aₘ, and the second number of occurrences of the m common words in the second text, textB, is text_Bₘ.

Step 802: Obtaining a second absolute difference between the first number of occurrences and the second number of occurrences, and determining a maximum value among the first number of occurrences and the second number of occurrences.

For example, the second absolute difference between the first number of occurrences and the second number of occurrences is |text_Aₘ−text_Bₘ|, and the maximum value between the first number of occurrences and the second number of occurrences is max (text_Aₘ, text_Bₘ).

Step 803: Determining the second word feature based on a ratio of the second absolute difference to the maximum value, wherein a value of the second word feature is negatively correlated with the similarity between the first text and the second text in the word dimension.

For example, given that the second word feature is denoted as b, then the calculation formula of the second word feature is:

$$b = \frac{\vert {text\_A}_{m} - {text\_B}_{m} \vert}{max ( {text\_A}_{m} , {text\_B}_{m} )} .$$

In the embodiments of the present disclosure, the second word feature b may denote the proportion of the absolute difference in the numbers of occurrences of the common words in textA and textB in max(text_Aₘ, text_Bₘ). The smaller the proportion, the closer the numbers of occurrences of the common words in the first text and the second text may be, the greater the degree of similarity between the first text and the text may be.

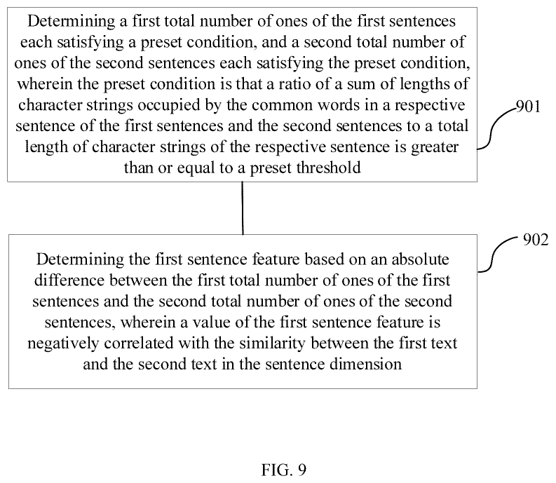

In a possible embodiment, the multi-dimensional similarity feature includes a first sentence feature that characterizes the sentence dimensional similarity feature, and the determining the multi-dimensional similarity feature for the first text and the second text based on multi-dimensional information includes the following operations as shown in FIG. 9.

FIG. 9 is a flowchart of a process for determining the multi-dimensional similarity feature for the first text and the second text according to one or more embodiments of the present disclosure. Referring to FIG. 9, the process includes the following steps S901 to S902.

Step 901: Determining a first total number of ones of the first sentences each satisfying a preset condition, and a second total number of ones of the second sentences each satisfying the preset condition, wherein the preset condition is that a ratio of a sum of lengths of character strings occupied by the common words in a respective sentence of the first sentences and the second sentences to a total length of character strings of the respective sentence is greater than or equal to a preset threshold.

For example, the preset condition is

$$\frac{{Z}_{m}}{{l}_{s}} \geq α ,$$

where lₛ denotes the total length of character strings of a certain sentence s, Zₘ denotes the sum of lengths of character strings occupied by the m common words in the sentence, and α is a preset threshold, where for example, the value of α is 0.8, and the value is not particularly limited, and may be set according to experience and requirements.

Further, in the embodiments of the present disclosure, it is possible to traverse all first sentences in the first text, determine whether each sentence satisfies the preset condition, and obtain a first total number S_{A} of sentences satisfying the preset condition in the first sentences. Similarly, it is possible to traverse all second sentences in the second text, and obtain a second total number S_{B} of sentences satisfying the preset condition in the second sentences.

Step 902: Determining the first sentence feature based on an absolute difference between the first total number of ones of the first sentences and the second total number of ones of the second sentences, wherein a value of the first sentence feature is negatively correlated with the similarity between the first text and the second text in the sentence dimension.

For example, given that the first feature is c, then the calculation formula of the second feature is: c=|S_{A}−S_{B}|.

In the embodiments of the present disclosure, the first sentence feature may denote the absolute value of the difference between the numbers of sentences satisfying the preset condition in the first text and the second text. The smaller the value of the first sentence feature, the more similar sentences there are in the first text and the second text, and therefore the greater the degree of similarity between the first text and the second text.

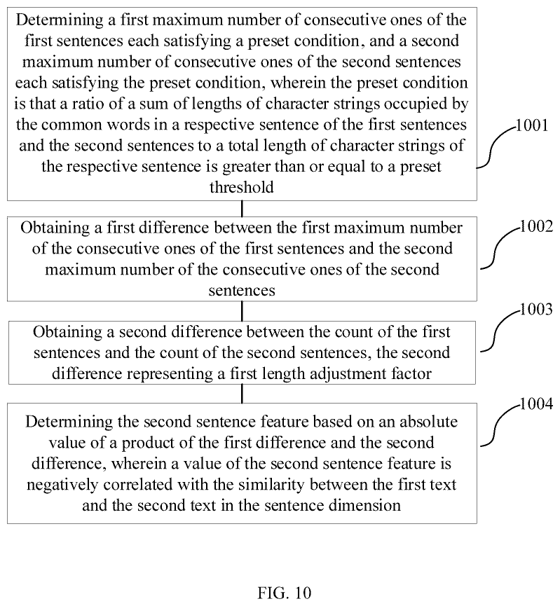

In a possible embodiment, the multi-dimensional similarity feature includes a second sentence feature that characterizes the sentence dimensional similarity feature, and the determining the multi-dimensional similarity feature for the first text and the second text based on multi-dimensional information includes the following operations as shown in FIG. 10.

FIG. 10 is a flowchart of a process for determining the multi-dimensional similarity feature for the first text and the second text according to one or more embodiments of the present disclosure. Referring to FIG. 10, the process includes the following steps S1001 to S1004.

Step 1001: Determining a first maximum number of consecutive ones of the first sentences each satisfying a preset condition, and a second maximum number of consecutive ones of the second sentences each satisfying the preset condition, wherein the preset condition is that a ratio of a sum of lengths of character strings occupied by the common words in a respective sentence of the first sentences and the second sentences to a total length of character strings of the respective sentence is greater than or equal to a preset threshold.

For example, if three consecutive sentences in the first text satisfy the preset condition, the number of consecutive sentences is 3. As such, a first maximum number of consecutive sentences satisfying the preset condition may be determined by sequentially traversing all the sentences in the first text, and the first maximum number of consecutive sentences is denoted as L(S_{A}). Similarly, a second maximum number L(S_{B}) of consecutive sentences satisfying the preset condition may be determined by traversing all the sentences in the second text.

Step 1002: Obtaining a first difference between the first maximum number of the consecutive ones of the first sentences and the second maximum number of the consecutive ones of the second sentences.

For example, the first difference is L(S_{A})−L(S_{B}).

Step 1003: Obtaining a second difference between the count of the first sentences and the count of the second sentences, the second difference representing a first length adjustment factor.

For example, given that the count of the first sentences is T_{A}, and the count of the second sentences is T_{B}, then the second difference value is T_{A}−T_{B}.

Step 1004: Determining the second sentence feature based on an absolute value of a product of the first difference and the second difference, wherein a value of the second sentence feature is negatively correlated with the similarity between the first text and the second text in the sentence dimension.

For example, given that the second sentence feature is denoted as d, then the calculation formula of the second sentence feature may be:

$$d = \vert ( {T}_{A} - {T}_{B} ) * ( L ( {S}_{A} ) - L ( {S}_{B} ) ) \vert .$$

In the embodiments of the present disclosure, the second sentence feature d denotes the absolute value of the product of the difference in the maximum numbers of consecutive sentences satisfying the preset condition and the difference in the total numbers of sentences in the first text and the second text. The smaller the value of the second sentence feature, the more maximum continuous similar sentences there are in the first text and the second text, indicating a higher degree of similarity at the sentence level between the first text and the second text. Here, (T_{A}−T_{B}) may denote the first length adjustment factor. For example, under a condition that (L(S_{A})−L(S_{B})) is known, the smaller the (T_{A}−T_{B}), the more balanced the proportions of maximum continuous similar sentences between the first text and the second text, and thus the higher the degree of similarity. In this way, in the embodiments of the present disclosure, based on this first length adjustment factor, the negative impact of length differences between the first text and the second text may be reduced, and the accuracy of similarity recognition between texts with large length differences may be improved.

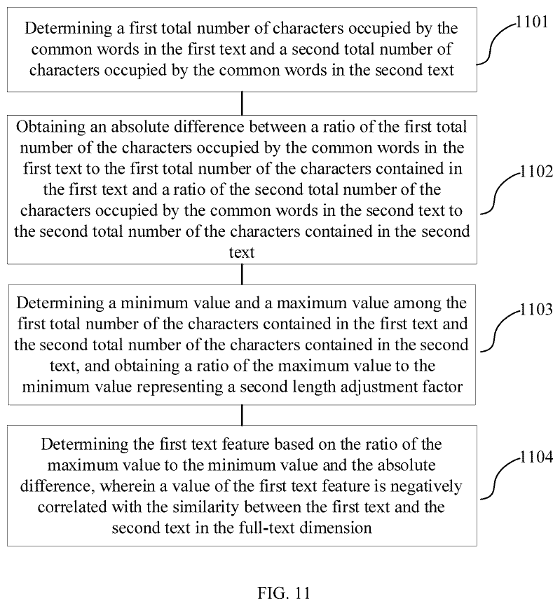

In a possible embodiment, the multi-dimensional similarity feature includes a first text feature that characterizes the full-text dimensional similarity feature, and the determining the multi-dimensional similarity feature for the first text and the second text based on multi-dimensional information includes the following operations as shown in FIG. 11.

FIG. 11 is a flowchart of a process for determining the multi-dimensional similarity feature for the first text and the second text according to one or more embodiments of the present disclosure. Referring to FIG. 11, the process includes the following steps S1101 to S1104.

Step 1101: Determining a first total number of characters occupied by the common words in the first text and a second total number of characters occupied by the common words in the second text.

For example, given that the count of the common words is m, the number of occurrences of each common word in the first text is m1, and the number of words included in each common word is m2, then the first total number of characters occupied by all common words in the first text is m*m1*m2, and it is likewise possible to determine the second total number of characters occupied by the common words in the second text.

Step 1102: Obtaining an absolute difference between a ratio of the first total number of the characters occupied by the common words in the first text to the first total number of the characters contained in the first text and a ratio of the second total number of the characters occupied by the common words in the second text to the second total number of the characters contained in the second text.

For example, given that the first total number of words is denoted by Aₘ, the second total number of words is denoted by Bₘ, the first total number of characters in the first text is denoted by Q_{A}, and the second total number of characters in the second text is denoted by Q_{B}, then the absolute value of the difference in proportions of characters occupied by the common words in the first text and the second text may be denoted by

$$\vert \frac{{Q}_{B} * {A}_{m} - {Q}_{A} * {B}_{m}}{{Q}_{A} * {Q}_{B}} \vert .$$

Step 1103: Determining a minimum value and a maximum value among the first total number of the characters contained in the first text and the second total number of the characters contained in the second text, and obtaining a ratio of the maximum value to the minimum value representing a second length adjustment factor.

For example, the minimum value between the first total number of characters and the second total number of characters is denoted as min(Q_{A}, Q_{B}), the maximum value between the first total number of characters and the second total number of characters is denoted as max(Q_{A}, Q_{B}), and the ratio of the maximum value to the minimum value is:

$$\frac{max ( {Q}_{A} , {Q}_{B} )}{min ( {Q}_{A} , {Q}_{B} )} .$$

Step 1104: Determining the first text feature based on the ratio of the maximum value to the minimum value and the absolute difference, wherein a value of the first text feature is negatively correlated with the similarity between the first text and the second text in the full-text dimension.

For example, given that the first text feature is denoted as e, the calculation formula of the first text feature may be expressed as:

$$e = \frac{max ( {Q}_{A} , {Q}_{B} )}{min ( {Q}_{A} , {Q}_{B} )} * \vert \frac{{Q}_{B} * {A}_{m} - {Q}_{A} * {B}_{m}}{{Q}_{A} * {Q}_{B}} \vert .$$

In the embodiments of the present disclosure, the first text feature may denote an absolute value of the difference in the proportions of characters occupied by the common words in the first text and the second text. The smaller the value of the first text feature, the greater the degree of similarity of the first text and the second text at the full-text level. The ratio

$$\frac{max ( {Q}_{A} , {Q}_{B} )}{min ( {Q}_{A} , {Q}_{B} )}$$

may denote the second length adjustment factor. For example, under a condition that

$$\vert \frac{{Q}_{B} * {A}_{m} - {Q}_{A} * {B}_{m}}{{Q}_{A} * {Q}_{B}} \vert$$

is known, the smaller the ratio

$$\frac{max ( {Q}_{A} , {Q}_{B} )}{min ( {Q}_{A} , {Q}_{B} )} ,$$

the more balanced the proportions of Aₘ and Bₘ in the first text and the second text, respectively, and thus the higher the degree of similarity. In the embodiments of the present disclosure, based on this second length adjustment factor, the similarity assessment between texts of different lengths may also be balanced, and it may also have good adaptability for texts with large length differences, improving the accuracy of similarity recognition.

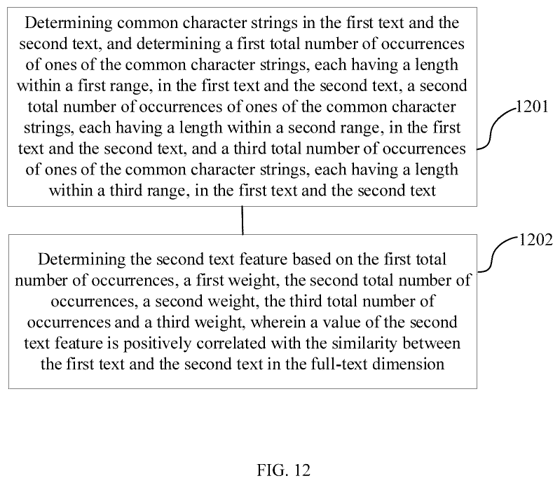

In a possible embodiment, the multi-dimensional similarity feature includes a second text feature that characterizes the full-text dimensional similarity feature, and the determining the multi-dimensional similarity feature for the first text and the second text based on multi-dimensional information includes the following operations as shown in FIG. 12.

FIG. 12 is a flowchart of a process for determining the multi-dimensional similarity feature for the first text and the second text according to one or more embodiments of the present disclosure. Referring to FIG. 12, the process includes the following steps S1201 to S1202.

Step 1201: Determining common character strings in the first text and the second text, and determining a first total number of occurrences of ones of the common character strings, each having a length within a first range, in the first text and the second text, a second total number of occurrences of ones of the common character strings, each having a length within a second range, in the first text and the second text, and a third total number of occurrences of ones of the common character strings, each having a length within a third range, in the first text and the second text.

For example, in the common character strings in the first text and the second text, the first total number of occurrences of ones of the common character strings, each having a length within a first range, in the first text and the second text is β₁, the second total number of occurrences of ones of the common character strings, each having a length within a second range, in the first text and the second text is β₂, and the third total number of occurrences of ones of the common character strings, each having a length within a third range, in the first text and the second text is β₃. For example, the first range is [100, ), the second range is [50, 100), and the third range is [10, 50), which are not limited in the embodiments of the present disclosure.

Step 1202: Determining the second text feature based on the first total number of occurrences, a first weight, the second total number of occurrences, a second weight, the third total number of occurrences and a third weight, wherein a value of the second text feature is positively correlated with the similarity between the first text and the second text in the full-text dimension.

For example, given that the second text feature is denoted as f, the calculation formula of the second text feature may be:

$$f = {β}_{1} * {γ}_{1} + {β}_{2} * {γ}_{2} + {β}_{3} * {γ}_{3}$$

where γ₁ is the first weight, γ₂ is the second weight, and γ₃ is the third weight, each representing the weight of the contribution to similarity from common character strings of a distinct length.

For example, γ₁ takes the value of 0.5, γ₂ takes the value of 0.3, and γ₃ takes the value of 0.2, and they can be set according to experience and requirements. In the embodiments of the present disclosure, the second text feature may denote the sum of the contributions to similarity from common character strings of different lengths in the first text and the second text. The larger the value of the second text feature, the greater the degree of similarity between the first text and the second text at the full-text level.

In addition, it should be noted that, in the embodiments of the present disclosure, the calculation formulas for the above several different dimensional similarity features are by way of examples only, and are not specifically limited.

In the embodiments of the present disclosure, the first text and the second text may be processed by word segmentation, sentence segmentation, etc., and the values of each feature may be calculated through the respective calculation formulas corresponding to the multi-dimensional similarity feature. In this way, features for similarity recognition between the first text and the second text may be obtained at different dimensions and levels, rather than considering only a single semantic level, which improves the accuracy of similarity recognition. Moreover, the calculation is simple and fast, improving efficiency.

Furthermore, since the embodiments of the present disclosure involves feature extraction from words, sentences, and the full-text of the first text and the second text, rather than semantic vector encoding, it is possible to know the common words, similar sentences, and other information between the first text and the second text during the feature extraction process. Based on this, the present disclosure also provides a possible implementation in which after determining the recognition result indicating similarity between the first text and the second text based on the multi-dimensional similarity feature, it also includes: under a condition that the first text and the second text are identified as being similar based on the similarity recognition result, displaying the common words between the first text and the second text in a predetermined manner.

The predetermined manner, for example, could involve highlighting or displaying in different colors within the first text and the second text. Additionally, it could involve presenting in the form of annotations in annotation boxes, or it could involve separate output, etc. In the embodiments of the present disclosure, there are no restrictions on these methods.

In this way, in the embodiments of the present disclosure, when determining similarity, common words may be displayed in a predetermined manner. In addition to displaying common words, sentences that meet the preset condition(s) may also be displayed, and there is no restriction on this. Users may easily know the similar portions and facilitate manual similarity review, further improving accuracy.

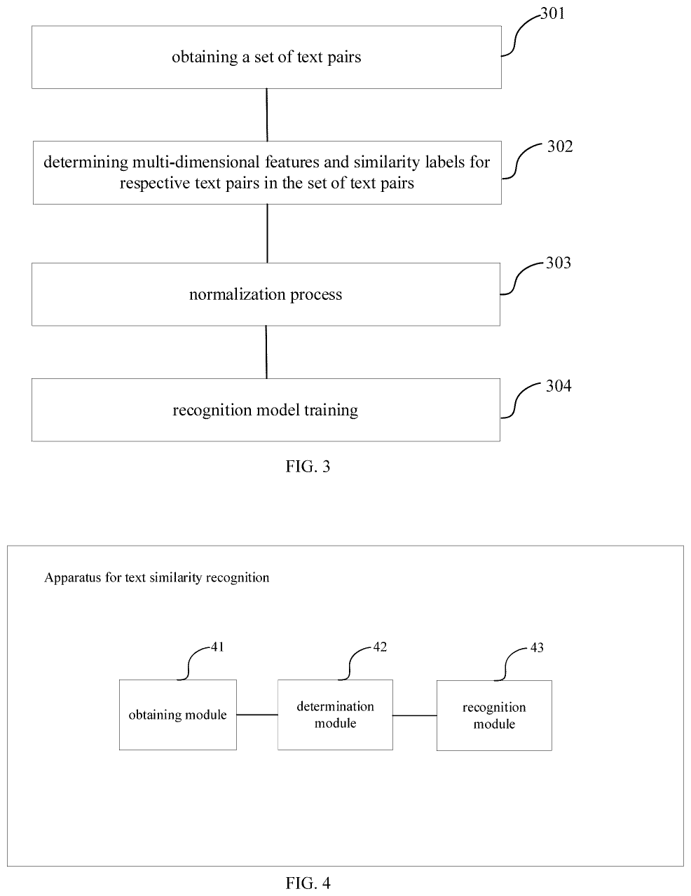

The following describes the training process of the recognition model in the embodiments of the present disclosure using a specific application scenario. Referring back to FIG. 3, FIG. 3 is a schematic flowchart of a process of training a recognition model according to one or more embodiments of the present disclosure. As shown in FIG. 3, the training process includes the following steps S301 to S304.

At step S301, a set of text pairs is obtained.

In the embodiments of the present disclosure, in order to improve the accuracy of text similarity recognition in different application scenarios, a plurality of texts from the desired application scenario(s) may be obtained. By combining them in pairs, a plurality of text pairs may be obtained, that is, the set of text pairs is obtained.

At step S302, multi-dimensional similarity features and similarity labels are determined for respective text pairs in the set of text pairs.

For example, for each text pair in the set of text pairs, similarity labels may be determined through manual labeling or other approaches, such as setting label 1 to indicate similarity and label 0 to indicate dissimilarity.

Moreover, in the embodiments of the present disclosure, calculation formulas for a multi-dimensional similarity feature have been pre-constructed. Taking a multi-dimensional similarity feature including the aforementioned first word feature, second word feature, first sentence feature, second sentence feature, first text feature, and second text feature as an example, the values of the six features for each text pair may be calculated according to the respective calculation formulas. Subsequently, based on the multi-dimensional similarity features and similarity labels of multiple text pairs, a training set of text pairs is obtained. For instance, as shown in Table 1, it serves as an example of the training set of text pairs in the embodiments of the present disclosure.

TABLE 1

| | First | Second | First | Second | First | Second | |
|---|---|---|---|---|---|---|---|
| | word | word | sentence | sentence | text | text | |
| Text | feature | feature | feature | feature | features | features | Similarity |
| pair | a | b | c | d | e | f | label |
| Text_1 | a₁ | b₁ | c₁ | d₁ | e₁ | f₁ | 0 |
| Text_2 | a₂ | b₂ | c₂ | d₂ | e₂ | f₂ | 1 |
| Text_3 | a₃ | b₃ | c₃ | d₃ | e₃ | f₃ | 0 |
| . . . | . . . | . . . | . . . | . . . | . . . | . . . | . . . |

At step S303, a normalization process is performed.

In the embodiments of the present disclosure, the values of each feature are subjected to normalization processing, which may reduce the impact of individual features being too dominant or too minor on the accuracy of the recognition model. The method of normalization is not restricted.

At step S304, a recognition model is trained.

In the embodiments of the present disclosure, the values of each feature in the multi-dimensional similarity feature of each text in the set of text pairs are converted into an array format as a feature value array X. Each feature value array corresponds to a similarity label. The set of text pairs may also be divided into a training set of text pairs and a test set of text pairs. Training is based on the training set of text pairs. Specifically, the X's corresponding to individual training texts are input into the recognition model to obtain the predicted similarity recognition result. Based on the predicted similarity recognition results and the similarity labels, the recognition model is trained until a predetermined number of iterations is reached or the loss function converges. The loss function may represent the loss between the predicted similarity recognition results and the similarity labels.

The loss function of the recognition model may use a normalized exponential function (softmax), a log-likelihood loss function, etc., and there is no restriction in the embodiments of the present disclosure. The network structure of the recognition model is also not restricted. Through training, continuously adjusting model's hyper-parameters, changing loss functions, increasing the amount of data, changing machine learning models, and other optimization methods, the trained recognition model is continuously refined. Subsequently, after training the recognition model, it may also be tested based on a test set of text pairs to improve the accuracy of the recognition model's similarity recognition.

In the embodiments of the present disclosure, after the recognition model is trained and tested, it may subsequently be used for similarity recognition. For any two texts, the multi-dimensional similarity feature is calculated and then input into the recognition model, which may output a result indicating whether they are similar or not.

In this way, in the embodiments of the present disclosure, through word segmentation, sentence segmentation, construction of a multi-dimensional similarity feature, normalization processing, and training of the recognition model, etc., similarity recognition between texts may be achieved. Features are constructed at different levels and dimensions from words, sentences, and the full-text, improving the accuracy of similarity recognition. The calculation is faster, improving the efficiency and processing speed of similarity recognition, and the similar portions between texts may be located for display, further improving the recognition performance.

It will be appreciated that each of the above-mentioned method embodiments mentioned in the present disclosure may be combined with each other to form a combined embodiment without departing from the principle logic, which will not be described in detail in the present disclosure. It will be appreciated by a person of ordinary skill in the art that in the above methods of the specific embodiments, the specific order of execution of the steps should be determined in terms of their function and possible intrinsic logic.

In addition, the present disclosure also provides an apparatus for text similarity recognition, an electronic device, and a computer-readable storage medium. The above may be used to implement any of the methods for text similarity recognition provided in the present disclosure.

FIG. 4 is a block diagram of an apparatus for text similarity recognition according to one or more embodiments of the present disclosure. Referring to FIG. 4, one or more embodiments of the present disclosure provides an apparatus for text similarity recognition which includes the following modules:
an obtaining module 41, configured to obtain a first text and a second text;
a determination module 42, configured to determine a multi-dimensional similarity feature for the first text and the second text, wherein the multi-dimensional similarity feature includes at least one of a word dimensional similarity feature, a sentence dimensional similarity feature, or a full-text dimensional similarity feature, the features of different dimensions being configured to characterize similarity between texts at different dimensional levels;
a recognition module 43, configured to determine a recognition result indicating similarity between the first text and the second text based on the multi-dimensional similarity feature.

In a possible embodiment, the determining module 42 is configured to:
perform word segmentation on the first text and the second text to obtain first words and a count thereof from the first text and second words and a count thereof from the second text;
determine common words and a count thereof between the first text and the second text based on the first words and the second words;
perform sentence segmentation on the first text and the second text to obtain first sentences and a count thereof from the first text and second sentences and a count thereof from the second text;
obtain a first total number of characters in the first text and a second total number of characters in the second text;
determine the multi-dimensional similarity feature for the first text and the second text based on multi-dimensional information, wherein the multi-dimensional information includes at least two of: the first words, the count of the first words, the second words, the count of the second words, the common words, the count of the common words, the first sentences, the count of the first sentences, the second sentences, the count of the second sentences, the first total number of characters, the second total number of characters.

In a possible embodiment, the multi-dimensional similarity feature includes a first word feature characterizing a word dimensional similarity feature, and the determining module 42, when determining the multi-dimensional similarity feature for the first text and the second text based on multi-dimensional information, is configured to:
determine a first absolute difference between the count of the first words and the count of the second words, and determining a first product of the count of the first words and the count of the second words;
obtain a second product of the first absolute difference and the count of the common words;
determine the first word feature between the first text and the second text based on a ratio of the second product to the first product, wherein a value of the first word feature is negatively correlated with a degree of similarity at a word level.

In a possible embodiment, the multi-dimensional similarity feature includes a second word feature characterizing a word dimensional similarity feature, and the determining module 42, when determining the multi-dimensional similarity feature for the first text and the second text based on multi-dimensional information, is configured to:
determine a first number of occurrences of the common words in the first text and a second number of occurrences of the common words in the second text;
determine a second absolute difference between the first number of occurrences and the second number of occurrences, and determining a maximum value between the first number of occurrences and the second number of occurrences;
determine the second word feature between the first text and the second text based on a proportion of the second absolute difference in the maximum value, wherein a value of the second word feature is negatively correlated with a degree of similarity at a word level.

In a possible embodiment, the multi-dimensional similarity feature includes a first sentence feature characterizing a sentence dimensional similarity feature, and the determining module 42, when determining the multi-dimensional similarity features for the first text and the second text based on multi-dimensional information, is configured to:
determine a first total number of sentences satisfying a preset condition in the first sentences and a second total number of sentences satisfying the preset condition in the second sentences, wherein the preset condition is characterized by a ratio of a sum of lengths of character strings occupied by the common words in a respective sentence to a total length of character strings of the sentence is greater than or equal to a preset threshold;
determine the first sentence feature between the first text and the second text based on an absolute difference between the first total number of sentences and the second total number of sentences, wherein a value of the first sentence feature is negatively correlated with a degree of similarity at a sentence level.

In a possible embodiment, the multi-dimensional similarity feature includes a second sentence feature characterizing a sentence dimensional similarity feature, and the determining module 42, when determining the multi-dimensional similarity features for the first text and the second text based on multi-dimensional information, is configured to:
determine a first maximum number of consecutive sentences satisfying a preset condition in the first sentences, and a second maximum number of consecutive sentences satisfying a preset condition in the second sentences, wherein the preset condition is characterized by a ratio of a sum of lengths of character strings occupied by the common words in a respective sentence to a total length of character strings of the sentence is greater than or equal to a preset threshold;
obtain a first difference between the first maximum number of consecutive sentences and the second maximum number of consecutive sentences;
obtain a second difference between the count of the first sentences and the count of the second sentences, wherein the second difference is used to characterize a first length adjustment factor;
determine a second sentence feature between the first text and the second text based on an absolute value of a product of the first difference and the second difference, wherein a value of the second sentence feature is negatively correlated with a degree of similarity at a sentence level.

In a possible embodiment, the multi-dimensional similarity feature includes a first text feature representing a whole-text dimensional similarity feature, and the determining module 42, when determining the multi-dimensional similarity features for the first text and the second text based on multi-dimensional information, is configured to:
determine a first total number of characters occupied by the common words in the first text and a second total number of characters occupied by the common words in the second text;
obtain an absolute value of a difference in proportions of characters occupied by the common words in the first text and the second text based on the first total number of words, the first total number of characters, the second total number of words, and the second total number of characters;
determine a minimum value and a maximum value between the first total number of characters and the second total number of characters, and obtaining a ratio of the maximum value to the minimum value, wherein the ratio of the maximum value to the minimum value is used to characterize a second length adjustment factor;
determine the first text feature between the first text and the second text based on the ratio and the absolute value of the difference in the proportions of characters occupied by the common words in the first text and the second text, wherein a value of the first text feature is negatively correlated with a degree of similarity at a full-text level.

In a possible embodiment, the multi-dimensional similarity feature includes a second text feature representing a whole-text dimensional similarity feature, and the determining module 42, when determining the multi-dimensional similarity features for the first text and the second text based on multi-dimensional information, is configured to:
determine a plurality of common character strings in the first text and the second text, and determining a first total number of occurrences of ones of the common character strings, each having a length within a first range, in the first text and the second text, a second total number of occurrences of ones of the common character strings, each having a length within a second range, in the first text and the second text, and a third total number of occurrences of ones of the common character strings, each having a length within a third range, in the first text and the second text;
determine the second text feature between the first text and the second text based on the first total number of occurrences and a first weight, the second total number of occurrences and a second weight, the third total number of occurrences and a third weight, wherein a value of the second text feature is positively correlated with a degree of similarity at a full-text level.

Each of the above-described text similarity recognition means may be implemented in whole or in part by software, hardware, and combinations thereof. The modules may be embedded in or independent of a processor in a computer device in hardware, or may be stored in a memory in a computer device in software to facilitate one or more calls by the processor to perform operations corresponding to the modules.

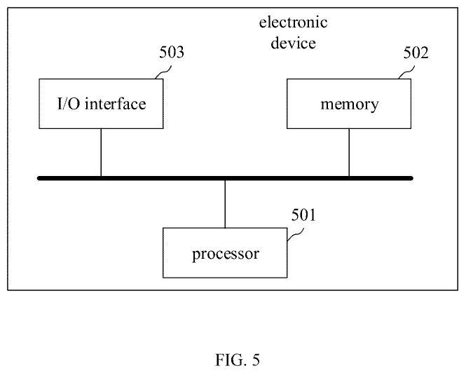

FIG. 5 is a block diagram of an electronic device according to one or more embodiments of the present disclosure. Referring to FIG. 5, one or more embodiments of the present disclosure provides an electronic device including at least one processor 501, at least one memory 502, and one or more input/output (I/O) interfaces 503 connected between the processor 501 and the memory 502; where the memory 502 stores one or more computer programs executable by the at least one processor 501, and the one or more computer programs when executed by the at least one processor 501 cause the at least one processor 501 to execute any of the methods of text similarity recognition described above.

Each of the modules in the electronic device may be implemented in whole or in part by software, hardware, or a combination thereof. The modules may be embedded in or independent of a processor in a computer device in the form of hardware, or may be stored in a memory in a computer device in the form of software to facilitate a call by the processor to perform operations corresponding to the modules.

One or more embodiments of the present disclosure further provides a computer-readable storage medium having stored thereon a computer program, wherein the computer program, when executed by a processor, implements any of the methods of text similarity recognition described above. The computer-readable storage medium may be a volatile or non-volatile computer-readable storage medium.

One or more embodiments of the present disclosure further provides a computer program product including computer-readable code, or a non-volatile computer-readable storage medium carrying the computer-readable code, where when the computer-readable code is run in a processor of an electronic device, the processor in the electronic device implements any of the methods of text similarity recognition described above.

It will be appreciated by a person of ordinary skill in the art that all or some of the steps, systems, functional modules/units in apparatuses in the methods disclosed above may be implemented as software, firmware, hardware, and a suitable combination thereof. In a hardware implementation, the partitioning between functional modules/units mentioned in the above description does not necessarily correspond to partitioning of physical components. For example, a physical component may have multiple functions, or a function or step may be cooperatively performed by several physical components. Some or all of the physical components may be implemented as software executed by a processor, such as a central processing unit, a digital signal processor, or a microprocessor, or as hardware, or as an integrated circuit, such as an application specific integrated circuit. Such software may be distributed on a computer-readable storage medium, which may include a computer storage medium (or a non-transitory medium) and a communication medium (or a transitory medium).

As is well known to a person of ordinary skill in the art, the term computer storage medium includes volatile and non-volatile, removable and non-removable media embodied in any method or technique for storing information, such as computer-readable program instructions, data structures, program modules, or other data. Computer storage media include, but are not limited to, random access memory (RAM), read only memory (ROM), erasable programmable read only memory (EPROM), static random access memory (SRAM), flash memory or other memory technology, portable compact disk read only memory (CD-ROM), digital versatile disk (DVD) or other optical disk storage, magnetic cassettes, magnetic tape, magnetic disk storage or other magnetic storage devices, or any other medium that may be used to store the desired information and that may be accessed by a computer. Furthermore, it is well known to a person of ordinary skill in the art that a communication medium generally contains computer-readable program instructions, data structures, program modules, or other data in a modulated data signal such as a carrier wave or other transmission mechanism, and may include any information delivery medium.

The computer-readable program instructions described herein may be downloaded from a computer-readable storage medium to various computing/processing devices, or via a network, such as the Internet, a local area network, a wide area network, and/or a wireless network, to an external computer or external storage device. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium in the respective computing/processing device.

The computer program instructions used to perform the operations of the present disclosure may be assembly instructions, instruction set architecture (ISA) instructions, machine instructions, machine-related instructions, microcode, firmware instructions, state setting data, or source or object code written in any combination of one or more programming languages, including object-oriented programming languages such as Smalltalk, C++, and the like, and conventional procedural programming languages such as the “C” language or similar programming languages. The computer-readable program instructions may be executed entirely on the user's computer, partially on the user's computer, as a stand-alone software package, partly on the user's computer and partly on the remote computer, or entirely on the remote computer or server. In the case of a remote computer, the remote computer may be connected to the user's computer through any type of network, including a local area network (LAN) or a wide area network (WAN), or may be connected to an external computer (e.g., connected through the Internet using an Internet service provider). In some embodiments, electronic circuits are personalized and customized by utilizing the state information of computer-readable program instructions, such as programmable logic circuits, Field-Programmable Gate Arrays (FPGAs), or Programmable Logic Arrays (PLAs). These electronic circuits may execute computer-readable program instructions, thereby implementing various aspects of the present disclosure.

The computer program product described herein may be embodied in hardware, software, or a combination thereof. In an alternative embodiment, the computer program product is embodied as a computer storage medium, and in another alternative embodiment, the computer program product is embodied as a software product, such as a Software Development Kit (SDK) or the like.

Various aspects of the present disclosure are described herein with reference to flow charts and/or block diagrams of methods, apparatus (systems), and computer program products in accordance with embodiments of the present disclosure. It should be understood that each block of the flowcharts and/or block diagrams, and combinations of blocks in the flowcharts and/or block diagrams, may be implemented by computer-readable program instructions.

These computer-readable program instructions may be provided to a processor of a general purpose computer, special purpose computer, or other programmable data processing apparatus to produce a machine such that, when executed by the processor of the computer or other programmable data processing apparatus, the instructions produce means for implementing the functions/acts specified in one or more blocks in the flowcharts and/or block diagrams. The computer-readable program instructions may also be stored in a computer-readable storage medium that cause a computer, programmable data processing apparatus, and/or other device to operate in a particular manner, such that the computer-readable medium having the instructions stored thereon includes an article of manufacture that includes instructions that implement various aspects of the functions/acts specified in one or more blocks in the flowcharts and/or block diagrams.

Computer-readable program instructions may also be loaded onto a computer, other programmable data processing apparatus, or other device such that a series of operational steps are performed on the computer, other programmable data processing apparatus, or other device to produce a computer-implemented process such that the instructions that execute on the computer, other programmable data processing apparatus, or other device implement the functions/actions specified in one or more blocks in the flowcharts and/or block diagrams.

The flowcharts and block diagrams in the drawings illustrate architectures, functions, and operations of possible implementations of systems, methods, and computer program products in accordance with various embodiments of the present disclosure. In this regard, each block in a flowchart or block diagram may represent a module, program segment, or portion of an instruction that contains one or more executable instructions for implementing a specified logical function. In some alternative implementations, the functions noted in the blocks may also occur in an order different from that noted in the drawings. For example, two successive blocks may actually be executed substantially in parallel, and they may sometimes be executed in the reverse order, depending on the functionality involved. It is also noted that each block of the block diagrams and/or flowcharts, and combinations of blocks in the block diagrams and/or flowcharts, may be implemented with a dedicated hardware-based system that performs the specified functions or actions, or may be implemented with a combination of dedicated hardware and computer instructions.

It will be appreciated by those of ordinary skill in the art that all or a portion of the steps of the above-described methods may be performed by instructing relevant hardware (e.g., a processor) through a program. The program may be stored in a computer-readable storage medium, such as a read-only memory, magnetic disk, or optical disk, etc. Alternatively, all or a portion of the steps of the above embodiments may be implemented using one or more integrated circuits. Accordingly, each module/unit in the above embodiments may be implemented in the form of hardware, for example through an integrated circuit (e.g., CPLD, FPGA, SoC, etc.) to realize its corresponding function, or may be implemented in the form of software functional module(s), for example through a processor executing a program/instruction stored in a memory to realize its corresponding function. The present disclosure is not limited to any particular form of combination of hardware and software.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

Example embodiments have been disclosed herein, and although specific terms have been employed, they are used only and should merely be interpreted in a generic and illustrative sense and not for purposes of limitation. In some instances, it will be apparent to a person of ordinary skill in the art that features, characteristics, and/or elements described in connection with particular embodiments may be used alone, or in combination with features, characteristics, and/or elements described in connection with other embodiments, unless specifically stated otherwise. Accordingly, a person of ordinary skill in the art will appreciate that various modifications in form and detail may be made without departing from the scope of the present disclosure as set forth in the appended claims.

What is claimed is:

1. A method for text similarity recognition, comprising: by an electronic device, obtaining a first text and a second text;
determining a multi-dimensional similarity feature for the first text and the second text, wherein the multi-dimensional similarity feature comprises at least one of a word dimensional similarity feature characterizing similarity between the first text and the second text in a word dimension, a sentence dimensional similarity feature characterizing similarity between the first text and the second text in a sentence dimension, or a full-text dimensional similarity feature characterizing similarity between the first text and the second text in a full-text dimension; and
determining, based on the multi-dimensional similarity feature, a recognition result indicating similarity between the first text and the second text.

2. The method of claim 1, wherein the determining of the multi-dimensional similarity feature comprises:
performing word segmentation on the first text and the second text to obtain first words of the first text, a count of the first words, second words of the second text, and a count of the second words;
determining common words in the first text and the second text and a count of the common words based on the first words and the second words;
performing sentence segmentation on the first text and the second text to obtain first sentences contained in the first text, a count of the first sentences, second sentences contained in the second text, and a count of the second sentences;
obtaining a first total number of characters contained in the first text and a second total number of characters contained in the second text; and
determining the multi-dimensional similarity feature for the first text and the second text based on multi-dimensional information comprising at least two of: the first words, the count of the first words, the second words, the count of the second words, the common words, the count of the common words, the first sentences, the count of the first sentences, the second sentences, the count of the second sentences, the first total number of the characters contained in the first text, or the second total number of the characters contained in the second text.

3. The method of claim 2, wherein the multi-dimensional similarity feature comprises a first word feature representing the word dimensional similarity feature; and
the determining of the multi-dimensional similarity feature for the first text and the second text based on the multi-dimensional information comprises:
obtaining a first absolute difference between the count of the first words and the count of the second words, and a first product of the count of the first words and the count of the second words;
obtaining a second product of the first absolute difference and the count of the common words; and
determining the first word feature based on a ratio of the second product to the first product, wherein a value of the first word feature is negatively correlated with the similarity between the first text and the second text in the word dimension.

4. The method of claim 2, wherein the multi-dimensional similarity feature comprises a second word feature representing the word dimensional similarity feature; and
the determining of the multi-dimensional similarity feature for the first text and the second text based on the multi-dimensional information comprises:
determining a first number of occurrences of the common words in the first text and a second number of occurrences of the common words in the second text;
obtaining a second absolute difference between the first number of occurrences and the second number of occurrences, and determining a maximum value among the first number of occurrences and the second number of occurrences; and
determining the second word feature based on a ratio of the second absolute difference to the maximum value, wherein a value of the second word feature is negatively correlated with the similarity between the first text and the second text in the word dimension.

5. The method of claim 2, wherein the multi-dimensional similarity feature comprises a first sentence feature representing the sentence dimensional similarity feature; and
the determining of the multi-dimensional similarity feature for the first text and the second text based on the multi-dimensional information comprises:
determining a first total number of ones of the first sentences each satisfying a preset condition, and a second total number of ones of the second sentences each satisfying the preset condition, wherein the preset condition is that a ratio of a sum of lengths of character strings occupied by the common words in a respective sentence of the first sentences and the second sentences to a total length of character strings of the respective sentence is greater than or equal to a preset threshold; and
determining the first sentence feature based on an absolute difference between the first total number of ones of the first sentences and the second total number of ones of the second sentences, wherein a value of the first sentence feature is negatively correlated with the similarity between the first text and the second text in the sentence dimension.

6. The method of claim 2, wherein the multi-dimensional similarity feature comprises a second sentence feature representing the sentence dimensional similarity feature; and
the determining of the multi-dimensional similarity feature for the first text and the second text based on the multi-dimensional information comprises:
determining a first maximum number of consecutive ones of the first sentences each satisfying a preset condition, and a second maximum number of consecutive ones of the second sentences each satisfying the preset condition, wherein the preset condition is that a ratio of a sum of lengths of character strings occupied by the common words in a respective sentence of the first sentences and the second sentences to a total length of character strings of the respective sentence is greater than or equal to a preset threshold;
obtaining a first difference between the first maximum number of the consecutive ones of the first sentences and the second maximum number of the consecutive ones of the second sentences;
obtaining a second difference between the count of the first sentences and the count of the second sentences, the second difference representing a first length adjustment factor; and
determining the second sentence feature based on an absolute value of a product of the first difference and the second difference, wherein a value of the second sentence feature is negatively correlated with the similarity between the first text and the second text in the sentence dimension.

7. The method of claim 2, wherein the multi-dimensional similarity feature comprises a first text feature representing the full-text dimensional similarity feature; and
the determining of the multi-dimensional similarity feature for the first text and the second text based on the multi-dimensional information comprises:
determining a first total number of characters occupied by the common words in the first text and a second total number of characters occupied by the common words in the second text;
obtaining an absolute difference between a ratio of the first total number of the characters occupied by the common words in the first text to the first total number of the characters contained in the first text and a ratio of the second total number of the characters occupied by the common words in the second text to the second total number of the characters contained in the second text;
determining a minimum value and a maximum value among the first total number of the characters contained in the first text and the second total number of the characters contained in the second text, and obtaining a ratio of the maximum value to the minimum value representing a second length adjustment factor; and
determining the first text feature based on the ratio of the maximum value to the minimum value and the absolute difference, wherein a value of the first text feature is negatively correlated with the similarity between the first text and the second text in the full-text dimension.

8. The method of claim 2, wherein the multi-dimensional similarity feature comprises a second text feature representing the full-text dimensional similarity feature; and
the determining of the multi-dimensional similarity feature for the first text and the second text based on the multi-dimensional information comprises:
determining common character strings in the first text and the second text, and determining a first total number of occurrences of ones of the common character strings, each having a length within a first range, in the first text and the second text, a second total number of occurrences of ones of the common character strings, each having a length within a second range, in the first text and the second text, and a third total number of occurrences of ones of the common character strings, each having a length within a third range, in the first text and the second text; and
determining the second text feature based on the first total number of occurrences, a first weight, the second total number of occurrences, a second weight, the third total number of occurrences and a third weight, wherein a value of the second text feature is positively correlated with the similarity between the first text and the second text in the full-text dimension.

9. An electronic device, comprising:
at least one processor; and
a memory communicatively connected with the at least one processor,
wherein the memory stores one or more computer programs executable by the at least one processor to perform operations comprising:
obtaining a first text and a second text;
determining a multi-dimensional similarity feature for the first text and the second text, wherein the multi-dimensional similarity feature comprises at least one of a word dimensional similarity feature characterizing similarity between the first text and the second text in a word dimension, a sentence dimensional similarity feature characterizing similarity between the first text and the second text in a sentence dimension, or a full-text dimensional similarity feature characterizing similarity between the first text and the second text in a full-text dimension; and
determining, based on the multi-dimensional similarity feature, a recognition result indicating similarity between the first text and the second text.

10. The electronic device of claim 9, wherein the determining of the multi-dimensional similarity feature comprises:
performing word segmentation on the first text and the second text to obtain first words of the first text, a count of the first words, second words of the second text, and a count of the second words;
determining common words in the first text and the second text and a count of the common words based on the first words and the second words;
performing sentence segmentation on the first text and the second text to obtain first sentences contained in the first text, a count of the first sentences, second sentences contained in the second text, and a count of the second sentences;
obtaining a first total number of characters contained in the first text and a second total number of characters contained in the second text; and
determining the multi-dimensional similarity feature for the first text and the second text based on multi-dimensional information comprising at least two of: the first words, the count of the first words, the second words, the count of the second words, the common words, the count of the common words, the first sentences, the count of the first sentences, the second sentences, the count of the second sentences, the first total number of the characters contained in the first text, or the second total number of the characters contained in the second text.

11. The electronic device of claim 10, wherein the multi-dimensional similarity feature comprises a first word feature representing the word dimensional similarity feature; and
the determining of the multi-dimensional similarity feature for the first text and the second text based on the multi-dimensional information comprises:
obtaining a first absolute difference between the count of the first words and the count of the second words, and a first product of the count of the first words and the count of the second words;
obtaining a second product of the first absolute difference and the count of the common words; and
determining the first word feature based on a ratio of the second product to the first product, wherein a value of the first word feature is negatively correlated with the similarity between the first text and the second text in the word dimension.

12. The electronic device of claim 10, wherein the multi-dimensional similarity feature comprises a second word feature representing the word dimensional similarity feature; and
the determining of the multi-dimensional similarity feature for the first text and the second text based on the multi-dimensional information comprises:
determining a first number of occurrences of the common words in the first text and a second number of occurrences of the common words in the second text;
obtaining a second absolute difference between the first number of occurrences and the second number of occurrences, and determining a maximum value among the first number of occurrences and the second number of occurrences; and
determining the second word feature based on a ratio of the second absolute difference to the maximum value, wherein a value of the second word feature is negatively correlated with the similarity between the first text and the second text in the word dimension.

13. The electronic device of claim 10, wherein the multi-dimensional similarity feature comprises a first sentence feature representing the sentence dimensional similarity feature; and
the determining of the multi-dimensional similarity feature for the first text and the second text based on the multi-dimensional information comprises:
determining a first total number of ones of the first sentences each satisfying a preset condition, and a second total number of ones of the second sentences each satisfying the preset condition, wherein the preset condition is that a ratio of a sum of lengths of character strings occupied by the common words in a respective sentence of the first sentences and the second sentences to a total length of character strings of the respective sentence is greater than or equal to a preset threshold; and
determining the first sentence feature based on an absolute difference between the first total number of ones of the first sentences and the second total number of ones of the second sentences, wherein a value of the first sentence feature is negatively correlated with the similarity between the first text and the second text in the sentence dimension.

14. The electronic device of claim 10, wherein the multi-dimensional similarity feature comprises a second sentence feature representing the sentence dimensional similarity feature; and
the determining of the multi-dimensional similarity feature for the first text and the second text based on the multi-dimensional information comprises:
determining a first maximum number of consecutive ones of the first sentences each satisfying a preset condition, and a second maximum number of consecutive ones of the second sentences each satisfying the preset condition, wherein the preset condition is that a ratio of a sum of lengths of character strings occupied by the common words in a respective sentence of the first sentences and the second sentences to a total length of character strings of the respective sentence is greater than or equal to a preset threshold;
obtaining a first difference between the first maximum number of the consecutive ones of the first sentences and the second maximum number of the consecutive ones of the second sentences;
obtaining a second difference between the count of the first sentences and the count of the second sentences, the second difference representing a first length adjustment factor; and
determining the second sentence feature based on an absolute value of a product of the first difference and the second difference, wherein a value of the second sentence feature is negatively correlated with the similarity between the first text and the second text in the sentence dimension.

15. The electronic device of claim 10, wherein the multi-dimensional similarity feature comprises a first text feature representing the full-text dimensional similarity feature; and
the determining of the multi-dimensional similarity feature for the first text and the second text based on the multi-dimensional information comprises:
determining a first total number of characters occupied by the common words in the first text and a second total number of characters occupied by the common words in the second text;
obtaining an absolute difference between a ratio of the first total number of the characters occupied by the common words in the first text to the first total number of the characters contained in the first text and a ratio of the second total number of the characters occupied by the common words in the second text to the second total number of the characters contained in the second text;
determining a minimum value and a maximum value among the first total number of the characters contained in the first text and the second total number of the characters contained in the second text, and obtaining a ratio of the maximum value to the minimum value representing a second length adjustment factor; and
determining the first text feature based on the ratio of the maximum value to the minimum value and the absolute difference, wherein a value of the first text feature is negatively correlated with the similarity between the first text and the second text in the full-text dimension.

16. The electronic device of claim 10, wherein the multi-dimensional similarity feature comprises a second text feature representing the full-text dimensional similarity feature; and
the determining of the multi-dimensional similarity feature for the first text and the second text based on the multi-dimensional information comprises:
determining common character strings in the first text and the second text, and determining a first total number of occurrences of ones of the common character strings, each having a length within a first range, in the first text and the second text, a second total number of occurrences of ones of the common character strings, each having a length within a second range, in the first text and the second text, and a third total number of occurrences of ones of the common character strings, each having a length within a third range, in the first text and the second text; and
determining the second text feature based on the first total number of occurrences, a first weight, the second total number of occurrences, a second weight, the third total number of occurrences and a third weight, wherein a value of the second text feature is positively correlated with the similarity between the first text and the second text in the full-text dimension.

17. A non-transitory computer-readable storage medium storing a computer program executable by a processor to perform operations comprising:
obtaining a first text and a second text;
determining a multi-dimensional similarity feature for the first text and the second text, wherein the multi-dimensional similarity feature comprises at least one of a word dimensional similarity feature characterizing similarity between the first text and the second text in a word dimension, a sentence dimensional similarity feature characterizing similarity between the first text and the second text in a sentence dimension, or a full-text dimensional similarity feature characterizing similarity between the first text and the second text in a full-text dimension; and
determining, based on the multi-dimensional similarity feature, a recognition result indicating similarity between the first text and the second text.

18. The storage medium of claim 17, wherein the determining of the multi-dimensional similarity feature comprises:
performing word segmentation on the first text and the second text to obtain first words of the first text, a count of the first words, second words of the second text, and a count of the second words;
determining common words in the first text and the second text and a count of the common words based on the first words and the second words;
performing sentence segmentation on the first text and the second text to obtain first sentences contained in the first text, a count of the first sentences, second sentences contained in the second text, and a count of the second sentences;
obtaining a first total number of characters contained in the first text and a second total number of characters contained in the second text; and
determining the multi-dimensional similarity feature for the first text and the second text based on multi-dimensional information comprising at least two of: the first words, the count of the first words, the second words, the count of the second words, the common words, the count of the common words, the first sentences, the count of the first sentences, the second sentences, the count of the second sentences, the first total number of the characters contained in the first text, or the second total number of the characters contained in the second text.

19. The storage medium of claim 18, wherein the multi-dimensional similarity feature comprises a first word feature representing the word dimensional similarity feature; and
the determining of the multi-dimensional similarity feature for the first text and the second text based on the multi-dimensional information comprises:
obtaining a first absolute difference between the count of the first words and the count of the second words, and a first product of the count of the first words and the count of the second words;
obtaining a second product of the first absolute difference and the count of the common words; and
determining the first word feature based on a ratio of the second product to the first product, wherein a value of the first word feature is negatively correlated with the similarity between the first text and the second text in the word dimension.

20. The storage medium of claim 18, wherein the multi-dimensional similarity feature comprises a second word feature representing the word dimensional similarity feature; and
the determining of the multi-dimensional similarity feature for the first text and the second text based on the multi-dimensional information comprises:
determining a first number of occurrences of the common words in the first text and a second number of occurrences of the common words in the second text;
obtaining a second absolute difference between the first number of occurrences and the second number of occurrences, and determining a maximum value among the first number of occurrences and the second number of occurrences; and
determining the second word feature based on a ratio of the second absolute difference to the maximum value, wherein a value of the second word feature is negatively correlated with the similarity between the first text and the second text in the word dimension.
